(19) United States
(12) Patent Application Publication
(10) Pub. No.: US 2017/0223572 A1
(43) Pub. Date: Aug. 3, 2017

(54) Method and Apparatus of Dynamic Weighted Load-balancing System

(71) Applicant: Lilee Systems, Ltd., San Jose, CA (US)

(72) Inventor: Yueh-Ju Lee, Saratoga, CA (US)

(73) Assignee: Lilee Systems, Ltd.

(21) Appl. No.: 15/417,174

(22) Filed: Jan. 26, 2017

Related U.S. Application Data
(60) Provisional application No. 62/288,435, filed on Jan. 29, 2016.

(51) Int. Cl. H04W 28/08; H04L 12/26; H04W 24/08

(52) U.S. Cl. CPC H04W 28/08; H04W 24/08; H04L 43/12; H04W 4/021

(57) ABSTRACT

Methods and apparatus for dynamic load balancing in a heterogeneous network are disclosed. In the present invention, incoming user packet flows are dynamically distributed to available links based on the weights determined for each link. The weights are determined based on link conditions, location information, user inputs, or a combination thereof. The link conditions include the delay, latency, jitter, drop rate, throughput, received signal strength indicator (RSSI) value, and collision for each link. The user inputs are used to provide user policies including carrier preference, link preference and usage limits. The location information is used to derive a geofencing policy provided by a GPS device. The incoming user packet flows distribution is periodic re-balanced according to a re-balance table. The re-balance table consists of catch-up values generated from a normalized flow hash table and a normalized fairness target table.

### CROSS REFERENCE TO RELATED APPLICATIONS

The present invention claims priority U.S. Provisional Patent Application No. 62/288,435, filed on Jan. 29, 2016, entitled “Method and Apparatus of Dynamic Weighted Load-balancing System”. The U.S. Provisional Patent Application is hereby incorporated by reference in its entirety.

### FIELD OF THE INVENTION

The present invention relates to load balancing in a heterogeneous network. In particular, the present invention relates to distributing multiple user packet flows to a set of heterogeneous links dynamically based on control inputs.

### BACKGROUND

Load balancing technique is used to distribute network traffic and assign each partition of the network traffic to one link connected to intended destinations (e.g. backend servers). By load balancing, the network traffic can be efficiently distributed across the links to maximize throughput, minimize response time, and/or avoid overload of any single resource. Flow based load balancing is widely used for distributing a network traffic with multiple incoming user packet flows across all available links. In many existing flow-based load balancing systems, the incoming user packet flows are uniquely defined by the source and destination internet protocol (IP) addresses, the protocol types, and the source and destination ports. After the incoming user packet flows are identified, the load balancer uniformly distributed all the incoming user packet flows across all available links to the servers. Each link carries the same amount of packet flows regardless of the link throughput and other characteristics. For example, in the case of distributing M incoming user packet flows across N links, each link will be equally assigned with (M/N) incoming user packet flows.

FIG. 1 illustrates an exemplary flow based load-balancing system. Users 110 generates a set of incoming user packet flows. The set of packet flows contain 12 flows illustrated by arrows 120a to 120l. In load balancer 130, each flow is defined by the source and destination IP addresses, protocol types, and source and destination ports. Four links, illustrated by links 141 to 144, are available to carry the incoming user packet flows. The 12 flows are equally partitioned into four bundles and each bundle is assigned to a link by using a hash or round robin algorithm. Table 131 shows a hash table used for distributing the incoming user packet flows to the links. The weight for each link can be considered as 1. Each of link 141 to link 144 carries (¼) of the incoming user packet flows to servers 150. As shown in FIG. 1, flow 120a to flow 120c are assigned to link 141 and flow 120d to flow 120f are distributed across link 142. Flow 120g to flow 120i are carried by link 143 and flow 120j to flow 120l are carried by link 144. In this example, link 141 and link 143 are faster links being underutilized and only a portion of each link is used to send the incoming user packet flows. Link 144 is a slower link being over-subscribed.

As shown in FIG. 1, equally divided the incoming user packet flows by the number of flows may result in unbalanced load distribution among the available links. Some incoming user packet flows may have built-in data rate regulation mechanism. The data rates of the incoming user packet flows may be different from each other. Flows carried by one link may occupy different portion of the link. For example, a video stream has a built-in data rate higher than the data rate of a voice stream. Being assigned to the same link, the video stream will use a larger portion of the link for communication than the voice stream. A file download flow usually tries to maximize the utilization of available link capacity.

Moreover, assigning same number of incoming user packet flows to each available link may over-subscribe some links and underutilize other links. In heterogeneous fixed or mobile network environment, the link conditions can vary significantly. The dynamically varying link conditions, such as link latency, drop rate and throughput, will cause the change of the network performance. For example, link latency changes when connecting with a new wired or wireless interface. The typical link latency for a connection by WiFi is about 5 ms, by long-term evolution (LTE) is about 50 ms, by general packet radio service (GPRS) is about 250 ms, by satellite is about 500 ms, by digital subscriber line (DSL) or cable is about 5 ms, and by a fiber is about 1 ms. The link with a short latency will result in more delay time and may have impact on quality of service for certain traffic types. Therefore, the variation of link conditions will cause some links to be over-subscribed or underutilized. The over-subscription will increase the delay or drop rate and degrade the service quality. The underutilization may decrease the efficiency of network performance especially at a peak time of communication.

The over-subscription and underutilization of available links will decrease the network efficiency and degrade the service quality. Therefore, it is desirable to develop dynamic load balancing that can dynamically re-distribute the user flows in response to various link conditions and/or user flow characteristics to improve the efficiency of load balancing.

### BRIEF SUMMARY OF THE INVENTION

A method and apparatus for managing multiple packet flows in a heterogeneous network are disclosed. Embodiments according to the present invention use a dynamic load balancing technique to distribute multiple incoming user packet flows or user packets across multiple heterogeneous links.

In one embodiment of the present invention, the method comprises receiving a set of incoming user packet flows or user packets, receiving control inputs and assigning the set of incoming user packet flows or user packets to a set of heterogeneous links. The control inputs comprise link conditions associated with the set of heterogeneous links, location information, user inputs, or a combination thereof. The set of heterogeneous links are used to provide communications among sources and destinations. The location information is associated with a location of a user. The set of incoming user packet flows or user packets is then assigned based on the control inputs to achieve dynamic load balancing.

The method may further comprise performing periodic flow re-balance according to a re-balance table. The re-balance table may be determined based on a table containing catch-up values calculated from a normalized flow hash table and a normalized fairness target table.

In another embodiment of the present invention, the apparatus of managing multiple packet flows in a heterogeneous network comprises one or more electronic circuits or processors. The one or more electronic circuits or processors are arranged to receive a set of incoming user packet flows or user packets, receive control inputs and assign the set of incoming user packet flows or user packets to a set of heterogeneous links. The control inputs comprise link conditions associated with the set of heterogeneous links, location information, user inputs, or a combination thereof. The set of heterogeneous links are used to provide communications among sources and destinations. The location information is associated with a location of a user. The set of incoming user packet flows or user packets is then assigned based on the control inputs to achieve dynamic load balancing. Said one or more electronic circuits or processors may be arranged to perform periodic flow re-balance according to a re-balance table. The re-balance table may be determined based on a table containing catch-up values calculated from a normalized flow hash table and a normalized fairness target table.

Said assigning the set of incoming user packet flows or user packets to the set of heterogeneous links may use a weight hash table with weights determined according to the control inputs. The link conditions may include delay, latency, jitter, drop rate, theoretical throughput, actual throughput, Received Signal Strength Indicator (RSSI) value, Reference Signal Received Power (RSRP), Reference Signal Received Quality (RSRQ), Signal-to-Noise Ratio (SNR), collision associated with each of the set of heterogeneous links, or any combination thereof. The delay, latency, jitter, drop rate and throughput may be measured using network probes. The RSSI, RSRP, RSRQ and SNR values and collision may be measured using radio frequency (RF) measurements.

The user inputs may comprise cost associated with the set of heterogeneous links, quality of service, service level agreement, location and time of day, or a combination thereof. The user inputs may be used to determine user policies for adjusting the weights. The user policies may include carrier preference, link preference, usage limits or a combination thereof. The link preference for digital subscriber line (DSL) may be higher than WiFi, and the link preference for WiFi may be higher than Cellular data.

The location information may be provided from a positioning device. A geofencing policy may be derived from the location information and used to adjust the weights.

### BRIEF DESCRIPTION OF THE DRAWINGS

FIG. 1 illustrates an exemplary load-balancing system using an existing flow based load balancing algorithm.

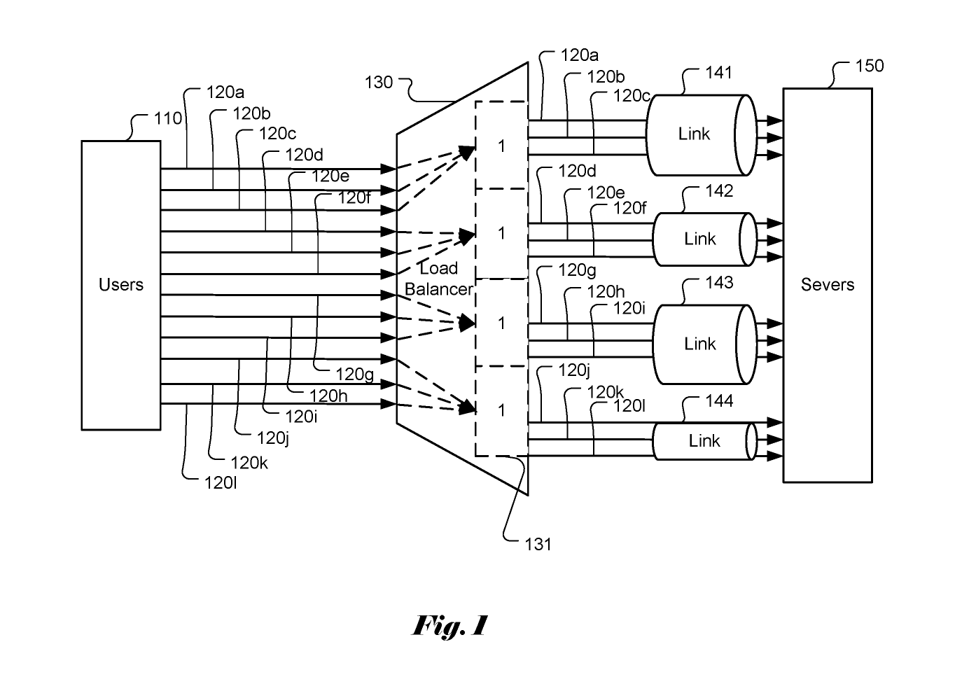

FIG. 2 illustrates an exemplary dynamic weighted load-balancing system according to one embodiment of the present invention.

FIG. 3A illustrates an exemplary block diagram of load-balancing using a dynamic weighted hashing table according to one embodiment of the present invention.

FIG. 3B illustrates another exemplary block diagram of load-balancing using a dynamic weighted hashing table according to one embodiment of the present invention.

FIG. 4 illustrates an example of load-balancing using a dynamic weighted hashing table according to one embodiment of the present invention.

FIG. 5 illustrates an exemplary load-balancing system with incoming user packet flows or user packets partitioned by number and distributed across multiple heterogeneous links.

FIG. 6 illustrates an exemplary flow chart of dynamic weighted load balancing according to one embodiment of the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

As mentioned above, the characteristics of the incoming user packet flows or user packets may be different from each other and the link conditions may vary significantly. In order to improve the efficiency of load balancing to avoid over-subscription or underutilization, dynamic weighted load-balancing techniques are developed. In the present invention, the incoming user packet flows or user packets in a heterogeneous network are distributed dynamically based on the control inputs, such as the link conditions, the location information and the user inputs.

According to one embodiment of the present invention, the control inputs are used to generate a weighted hash table with weights determined for each heterogeneous link. The incoming user packet flows or user packets are proportionally distributed across the available links by using the weighted hash table. A faster link with a higher weight will be used to carry a higher fraction of the incoming user packet flows or user packets.

The variation of the available links will be compensated dynamically based on the link conditions. The link conditions used for weight calculating include the delay, latency, jitter, drop rate, theoretical throughput, actual throughput, Received Signal Strength Indicator (RSSI) value, Reference Signal Received Power (RSRP), Reference Signal Received Quality (RSRQ), Signal-to-Noise Ratio (SNR), collision associated with each of the set of heterogeneous links, or any combination thereof.

In the present invention, the incoming user packet flows or user packets can also be directed to certain links according to the user inputs. The system can direct the use packet flows towards certain links based on the parameters associated with the links, quality of server, service level agreement, location and time of day, or any combination of them. A location of a user can be determined and used as a factor for load balancing. Various user inputs can be taken into account for load balance. For example, users can select a service provider, the service quality, the data usage limit and the cost limit for a network service. The user inputs can be a combination of cost preference of the available links, quality of service, service level agreement, location and time of day. Based on the user inputs, the user policies can be derived and used for adjusting the weights for load balancing. The user policy of one user determines the priority order for selecting links for the user. For example, a lower priority link can be used to carry an incoming user packet flow after it drops from a higher priority link. A user's location and request time can also be used to determine the distribution of the incoming user packet flows or user packets.

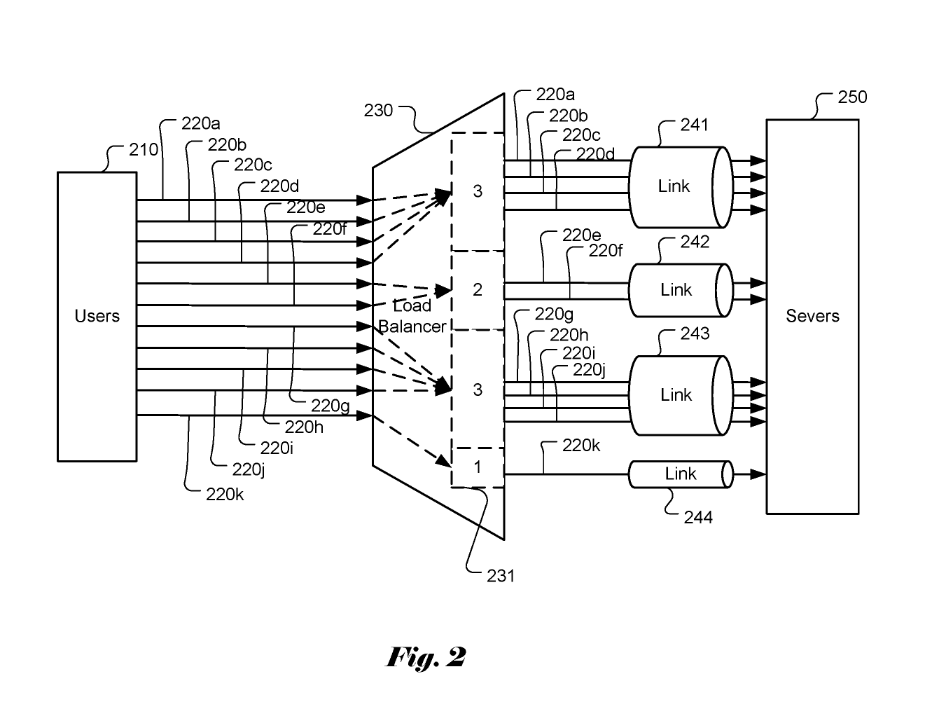

FIG. 2 illustrated an exemplary dynamic weighted load-balancing system according to one embodiment of the present invention. In a heterogeneous network system, users 210 generate 11 incoming user packet flows illustrated by arrows from 220a to 220k. In load balancer 230, weighted hash table 231 is used to distribute the incoming user packet flows to the available links. The weight in weighted hash table 231 is determined for each of link 241 to link 244. Link 241 and link 243 are faster links with a higher weight of 3. Link 242 and link 244 are slower links. The weight of link 242 is 2 and the weight of link 244 is 1. The incoming user packet flows or user packets are partitioned and hashed to each link based on the weight of each link. As shown in FIG. 2, link 241 and link 243 are used to carry a larger portion of the incoming user packet flows or user packets to servers 250. Flows 120a to 120d are assigned to link 241 and flows 220g to 220j are allocated to link 243. Link 242 with a smaller weight is assigned with flows 220e and 220f. Link 244 with the smallest weight is only assigned with flow 220k. In FIG. 2, an example of dynamic load balancing according to an embodiment of the present invention is illustrates with specific number of user flows and number of links. It is understood that the present invention is not limited to these specific number of user flows and number of links.

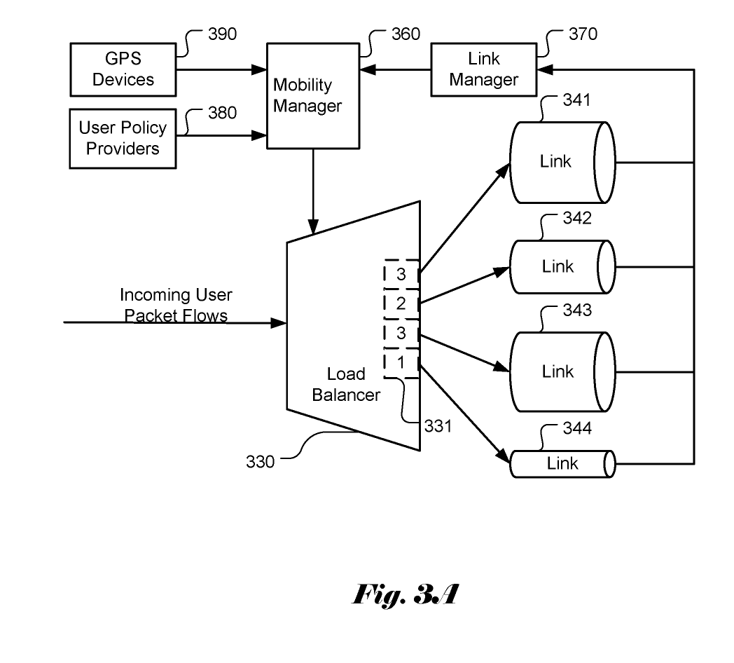

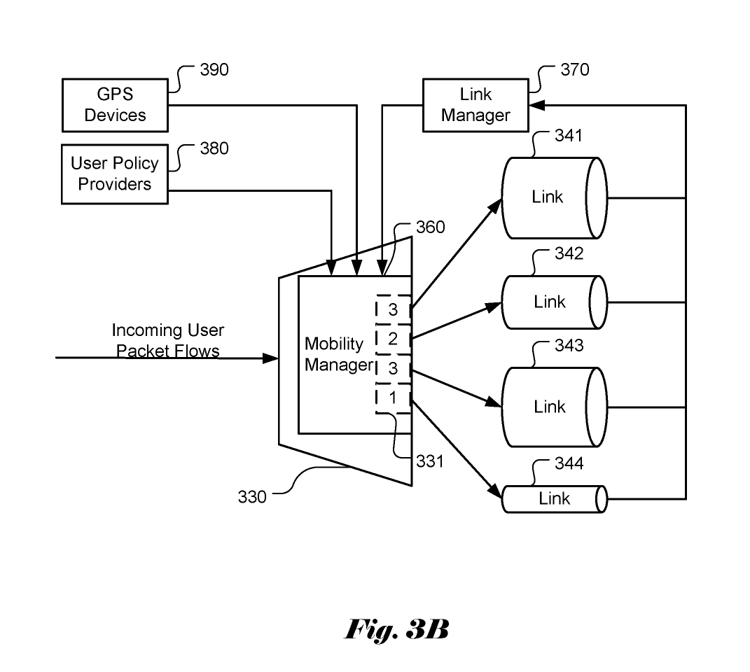

The weighted hash table is dynamically determined based on control inputs. FIG. 3A illustrates an exemplary dynamic weighted load balancing by using a mobility manager to determine the weight for each link. In load balancer 330, the incoming user packet flows or user packets are received and each flow is defined based on the information extracted from the flow. After determining the available links, mobility manager 360 accepts the control inputs from link manager 370, user policy providers 380, Global Positioning System (GPS) devices 390 to determine the distribution of the incoming user packet flows or user packets. While GPS devices are shown in FIG. 3 for determining the location of a user, any other position device can be used. For example, beside GPS, there are several other satellite-based navigation systems such as the European Union's Galileo, BeiDou Navigation Satellite System developed by China and Global Navigation Satellite System, GLONASS developed by Russia. In addition, crowdsourced WiFi AP based positioning can also be used. Link manager 370 provides link conditions of the four available heterogeneous links from link 341 to link 344. The link conditions include delay, latency, jitter, drop rate, theoretical throughput, actual throughput, Received Signal Strength Indicator (RSSI) value, Reference Signal Received Power (RSRP), Reference Signal Received Quality (RSRQ), Signal-to-Noise Ratio (SNR), collision, or any combination thereof for each of the four links. The link conditions are used to determine a proper load that the link can share. User policy providers 380 are used to provide user inputs such as link preference based on the cost, application latency and throughput requirements. The user policy providers can be a group of user's devices or be made of electronic circuits in each user's device. Based on the user policy of one user, load balancer 330 determines how to distribute the user's flows across the links. GPS devices 390 provide location information associated with a location of a user indicated by the GPS. The location information can be used as triggers for weight changes. When a user moves out of or inside a geofencing area, it can trigger the weight change of the available links.

Mobility manager 360 uses the control inputs to generate weighted hash table 331 to distribute the incoming user packet flows or user packets proportionally to a link according to the weight determined for the link. As shown in FIG. 3A, the weight of link 341 is 3, the total weight of all links is 9. Then, link 341 is used to carry ( 3/9) of the incoming user packet flows or user packets. In FIG. 3A, the Mobility manager 360 is external to the load balancer 330. However, in another embodiment of the present invention, mobility manager 360 is embedded in the load balancer as shown by FIG. 3B.

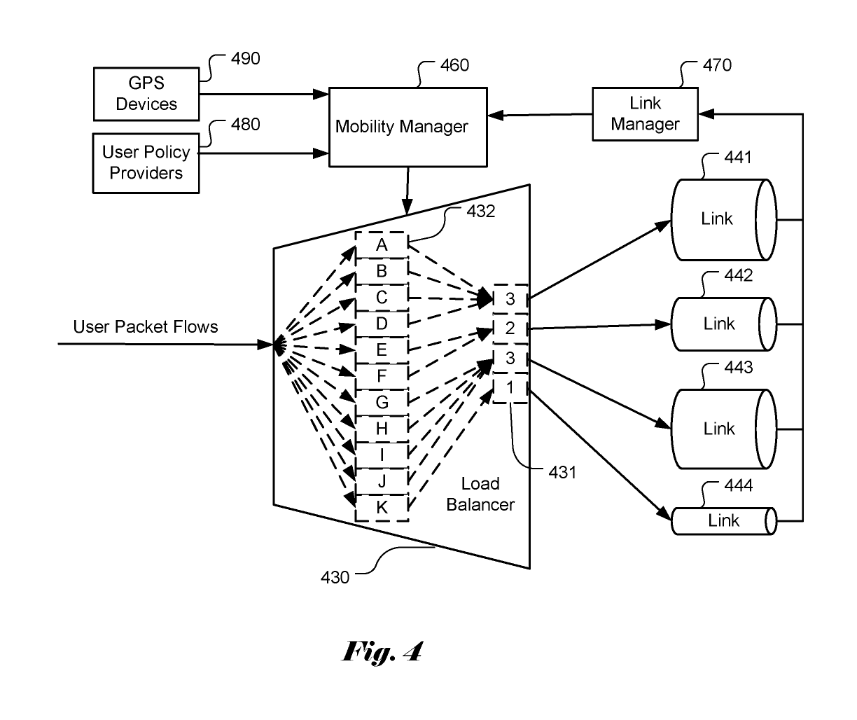

FIG. 4 illustrates another example for dynamic weighted load balancing by using a hashing algorithm. Similar to the example shown in FIG. 3A, mobility manager 460 uses the control inputs to dynamically distribute the incoming user packet flows or user packets across four links from 441 to 444 according to the weight for each link. The control inputs are provided by link manager 470, user policy providers 480 and GPS devices 490. In load balancer 430, the incoming user packet flows or user packets are hashed according to table 432 defined by the source and destination IP addresses, protocol types, and source and destination ports. Table 432 contains 11 buckets illustrated by bucket A to bucket K and each bucket is used for one type of user packet flow. Then based on the weights determined by the control inputs, the incoming user packet flows or user packets in the 11 buckets are hashed according to weighted table 431. The incoming user packet flows or user packets in buckets A to D are put into the bucket weighted 3 for link 441. The incoming user packet flows or user packets in buckets E and F are hashed to the bucket weighted 2 for link 442. The buckets G, H, I and J are hashed to the bucket weighted 3 forward to link 443. The incoming user packet flows or user packets in bucket K are put into the bucket weighted 1 for link 444.

Link manager 470 determines the link condition using the link type, network probes and RF measurements. By using network probes, the delay, latency, jitter, drop rate and throughput can be measured for each link. The RF measurements are used to determine the RSSI value and collision. Based on the link conditions, the mobility manager determines or adjusts the weights for the available links. For example, the weights can be adjusted based on the RSSI value determined for each link. In typical conditions, the value of RSSI will increase when the user device moving close to a base-station coverage area. The RSSI value will decrease when the user device moving away from a base-station coverage area. By comparing the average value of RSSI in two consecutive time periods, the RSSI trend can be predicted for the following time period. The period may be a packet period, an OFDM block period or other time period. The trend of change, Δ in RSSI can be performed by subtracting the average values of RSSI at two consecutive time periods,

Δ=Avg(RSSI(t−1))−Avg(RSSI(t)).

Then, the RSSI trend is used as a predictor for the weight change.

User policy providers 480 provide carrier preference, link preference and usage limits for each user to determine the distribution of the incoming user packet flows or user packets. For example, the link preference of a user indicates that an order of service provider is selected from service provider A, service provider B and service provider C. A user's link preference for digital subscriber line (DSL) can be higher than WiFi, and the user's link preference for WiFi can be higher than Cellular data.

GPS devices 490 provide GPS coordinates used for control the load balancing, such as triggers for weight changes. Based on the GPS coordinates of a user's location, a geofencing policy can be derived and used to adjust the weights of weighted hash table 431. According to the geofence of a user's location, the available wired or wireless interfaces can be determined for the user. If a less expensive interface is available for a user, mobility manager 460 can assign the user's packet flows to the less expensive interface. If a user moves into or out of an area predefined by the geofencing marked on the map, a trigger will be provided to the mobility manager to change the weights.

In weighted hash algorithm, the incoming user packet flows or user packets are partitioned by the number of flows according the weighted hash table, which may cause a link be over-subscribed or under-utilized. If the incoming user packet flows or user packets consist of M flows and the weight of link i is Wᵢ, then link i will be assigned with (M×Wᵢ/ΣWᵢ) flows. However, the difference of the data rate may still cause imbalance of workload distribution based on the partition by the number of the incoming user packet flows or user packets. Some flows, such as voice or video flows, usually have built-in data rate regulation mechanism. If the data rate of a video flow is higher than the data rate of a voice flow, the video flow may take a higher portion of a link than the voice flow. A file download traffic typically will take the maximize portion of a link.

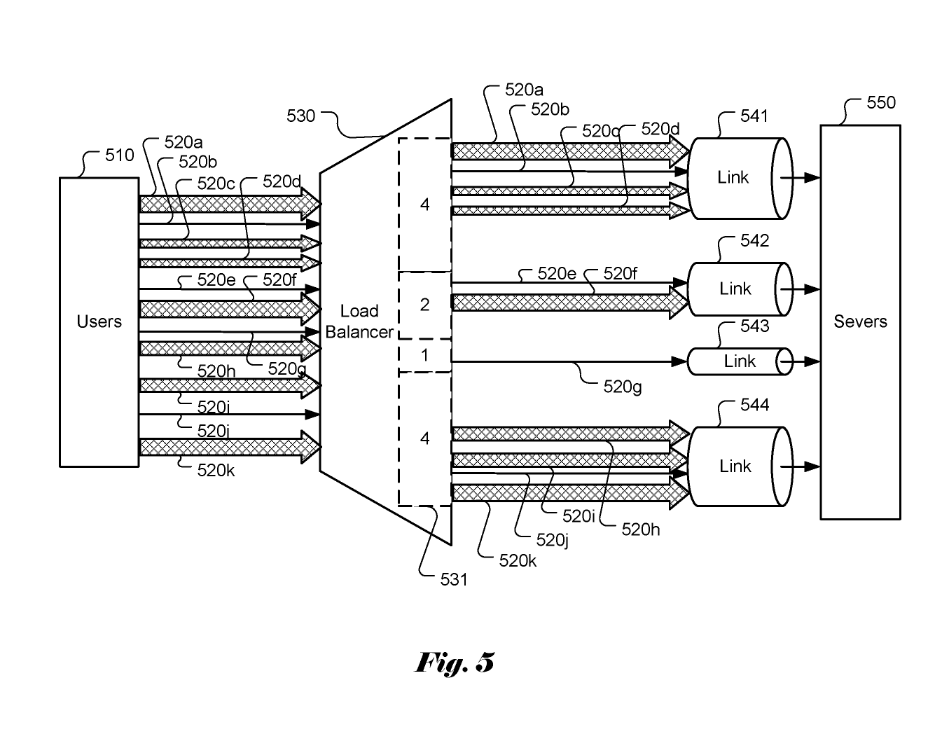

FIG. 5 illustrates an exemplary dynamic weighted load balancing with incoming user packet flows or user packets having different data rate. The incoming user packet flows or user packets consist of 11 flows illustrated by flow 520a to flow 520k. Flows 520a, 520f, 520h, 520i and 520k have a higher data rate then other flows. On the other hand, flows 520b, 520e, 520g and 520j have a lowest data rate. The flow with a higher data rate will be assigned a larger portion of a link compared with the flow with a lower data rate. By assigning a number of flows with a higher total data rate to a link, the link can be over-utilized. As shown in FIG. 5, link 544 is assigned with flows 520h to 520k. The total data rate of the four flows may be exceeded the capacity of link 544 over time. This will increase the drop rate and delay along link 544 and result in the degradation of service quality.

Moreover, the randomness of the incoming user packet flows or user packets will result in some links to be over-subscribed or under-utilized. The incoming user packet flows or user packets may be concentrated on a certain portion of the weighted hash table due to the nature of the user data access pattern. The randomness of the incoming user packet flows or user packets will cause the imbalance of workload distribution across the links.

In order to adjust the load balancing dynamically based on the flow conditions, flow rebalancing is used to compensate the imbalance caused by the randomness of the flows and the difference in the data rate. In one embodiment of the present invention, flows with a higher total data rate will be distributed to a faster link and a periodic re-balance is used to adjust the flow distribution based on a re-balance table. Table 1 illustrates an example of re-balance table generated based on the catch-up values calculated for each flow. The incoming user packet flows or user packets are defined and hashed to 11 flow buckets represented by A to K. The data rate of each flow bucket is detected by using a byte counter. A normalized flow hash table is generated based on the detected results for all the links. Each normalized flow hash value represents the normalized data rate of a flow bucket. Normalized Fairness target values are predefined for the incoming user packet flows or user packets. In the example shown in table 1, the normalized fairness target value for each flow bucket is 9. By subtracting the normalized flow hash value from the normalized fairness target value of one flow bucket, the catch-up value is calculated for the flow bucket and used for periodic re-balance. For example, the catch-up value for flow bucket A is 2, which means another two flows can be assigned to flow bucket A during the next re-balance period. Similarly, another one flow can be assigned to flow bucket C, I and K. Flow bucket D can be allocated another five flows and flow bucket F can be assigned additional three flows. The re-balance period should be long enough to avoid flow bouncing. The re-balance period may be set equal to or longer than a packet period.

TABLE 1

| | Bucket | | | | | | | | | | |
|---|---|---|---|---|---|---|---|---|---|---|---|
| Value type | A | B | C | D | E | F | G | H | I | J | K |
| Normalized | 9 | 9 | 9 | 9 | 9 | 9 | 9 | 9 | 9 | 9 | 9 |
| Fairness Target | | | | | | | | | | | |
| Normalized Flow | 7 | 9 | 8 | 4 | 9 | 6 | 9 | 9 | 8 | 9 | 8 |
| Hash Value | | | | | | | | | | | |
| Catch-up Value | 2 | 0 | 1 | 5 | 0 | 3 | 0 | 0 | 1 | 0 | 1 |

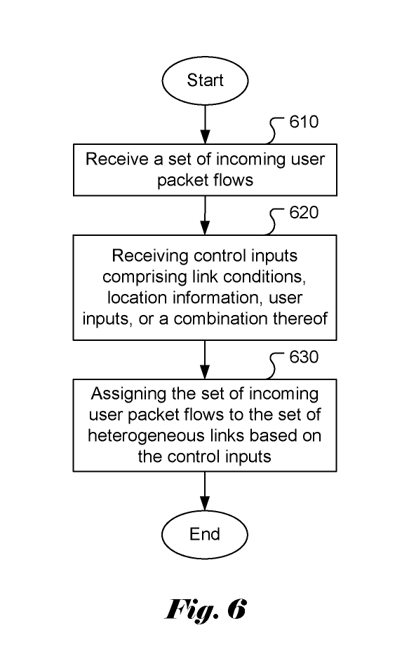

FIG. 6 illustrates a flow chart of managing multiple user packet flows or user packets in a heterogeneous network. Load balance receives a set of incoming packet flows in step 610. Then, control inputs are received in step 620. The control inputs comprise link conditions, location information, user inputs, or a combination thereof. The link conditions are associated with a set of heterogeneous links to provided communications among sources and destinations. The location information is associated with a location of a user. Based on the control inputs, the set of incoming user packet flows or user packets are dynamically assigned to the set of heterogeneous links in step 630. In one embodiment of the present invention, a periodic re-balancing step is performed after step 630 and before sending all packets of the incoming user packet flows or user packets. The periodic re-balancing is used to adjust the flow distribution among the set of heterogeneous links based on catch-up table with catch-up values. The catch-up values are calculated from a normalized flow hash table and a normalized fairness target table.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be a circuit integrated into a chip or program code integrated into software to perform the processing described herein. The invention may also involve a number of functions to be performed by a computer processor, a digital signal processor, or a microprocessor. These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of managing multiple packet flows in a heterogeneous network, the method comprising:
receiving a set of incoming user packet flows or user packets;
receiving control inputs comprising link conditions, location information, user inputs, or a combination thereof, wherein the link conditions are associated with a set of heterogeneous links to provide communications among sources and destinations, and the location information is associated with a location of a user; and
assigning the set of incoming user packet flows or user packets to the set of heterogeneous links based on the control inputs to achieve dynamic load balancing.

2. The method of claim 1, wherein said assigning the set of incoming user packet flows to the set of heterogeneous links uses a weighted hash table having weights determined according to the control inputs.

3. The method of claim 2, wherein the link conditions include delay, latency, jitter, drop rate, theoretical throughput, actual throughput, Received Signal Strength Indicator (RSSI) value, Reference Signal Received Power (RSRP), Reference Signal Received Quality (RSRQ), Signal-to-Noise Ratio (SNR), collision associated with each of the set of heterogeneous links, or any combination thereof.

4. The method of claim 3, wherein the delay, latency, jitter, drop rate and throughput are measured using network probes.

5. The method of claim 3, wherein the RSSI value and collision are measured using RF measurements.

6. The method of claim 2, wherein the user inputs comprise cost associated with the set of heterogeneous links, quality of service, service level agreement, location and time of day, or a combination thereof.

7. The method of claim 6, wherein user policies are determined based on the user inputs for adjusting the weights, wherein the user policies include carrier preference, link preference, usage limits or a combination thereof.

8. The method of claim 7, wherein the link preference for digital subscriber line (DSL) is higher than WiFi, and the link preference for WiFi is higher than Cellular data.

9. The method of claim 2, wherein the location information is provided from a positioning device.

10. The method of claim 9, wherein a geofencing policy is derived from the location information and used to adjust the weights.

11. The method of claim 1, comprising performing periodic flow re-balance according to a re-balance table.

12. The method of claim 11, wherein the re-balance table is determined based on a table containing catch-up values calculated from a normalized flow hash table and a normalized fairness target table.

13. An apparatus of managing multiple packet flows in a heterogeneous network, the apparatus comprising one or more electronic circuits or processors arranged to:
receive a set of incoming user packet flows;
receive control inputs comprising link conditions, location information, user inputs, or a combination thereof, wherein the link conditions are associated with a set of heterogeneous links to provide communications among sources and destinations, and the location information is associated with a location of a user; and
assign the set of incoming user packet flows to the set of heterogeneous links based on the control inputs to achieve dynamic load balancing.
